(19) United States
(12) Patent Application Publication
(10) Pub. No.: US 2007/0041068 A1
(43) Pub. Date: Feb. 22, 2007

(54) Apparatus and methods for rapidly bringing a scanning mirror to a selected deflection amplitude at its resonant frequency

(76) Inventors: Mark David Heminger, Rochester, MN (US); James Eugene Noxon, Rochester, MN (US)

Correspondence Address: TEXAS INSTRUMENTS INCORPORATED, P O BOX 655474, M/S 3999, DALLAS, TX, 75265, US

(21) Appl. No.: 11/353,869

(22) Filed: Feb. 14, 2006

Related U.S. Application Data
(60) Provisional application No. 60/653,168, filed on Feb. 14, 2005.

(51) Int. Cl. G02B 26/08

(52) U.S. Cl. 359/199

(57) ABSTRACT

The present invention provides methods and apparatus for rapidly starting or bringing an oscillating device to its resonant frequency, and operating deflection amplitude. The invention is particularly applicable for use with an oscillating mirror used as the scanning engine of a laser printer. Control circuitry of the oscillating device first determines the resonant frequency of the device and then adjusts or increases the duty cycle of successive energy drive pulses until a selected deflection amplitude is reached. Energy drive pulses at the resonant frequency of the device and the adjusted duty cycle are then provided to maintain oscillation of the device. In a laser printer, a single sensor is used to determine the deflection amplitude of the resonant beam sweep by determining the spacing or timing between a pair of the sensors pulses.

This application claims the benefit of U.S. Provisional Application No. 60/653,168, filed on Feb. 14, 2005, entitled Deflection Controller For A Resonant Scanning Mirror, which application is hereby incorporated herein by reference.

### TECHNICAL FIELD

The present invention relates generally to the field of torsional hinge MEMS scanning devices such as mirrors, and more particularly to methods and apparatus for rapidly bringing the scanning device to a selected deflection amplitude and to the resonant frequency at start up. The method and apparatus of the invention is also useful for maintaining the selected deflection amplitude and resonant frequency even in the event of temperature changes, large transients signals or a controller failure that could cause damage to the mirror.

### BACKGROUND

The use of rotating polygon scanning mirrors in laser printers to provide a beam sweep or scan of the image of a modulated light source across a photosensitive medium, such as a rotating drum, is well-known. Unfortunately, rotating polygon mirrors must be manufactured to very tight tolerances and rotated at a precise speed so that each facet of the polygon mirror reflects a scanning laser beam in a consistent manner. These strict requirements result in a mirror system that is bulky, expensive, and that uses a substantial amount of power during operation.

More recently, it has become well known to replace the expensive rotating polygon mirror drive engine with a torsional hinged flat mirror that oscillates at a known resonant frequency. Texas Instruments presently manufactures MEMS mirror devices fabricated out of a single piece of material such as silicon, for example, using semiconductor manufacturing processes. These mirrors have dimensions on the order of a few millimeters and are supported by two silicon torsional hinges. The hinges of such devices or mirrors act as torsional springs that work to return the device to a center position if it is deflected or rotated about the hinges. However, when the device or mirror returns to its central position, it overshoots the center position and continues in the opposite direction. The torsional hinges again act to return the device to the center position. This sequence repeats many times at a specific frequency known as the resonant frequency.

If the device is continuously driven at or near its resonant frequency, the deflection amplitude can increase to a very wide angle. This is desirable up to a point, as it allows a low power drive signal to oscillate the device over a large angle. Unfortunately, if the deflection amplitude becomes too large, the hinges may be overstressed to the point that they shatter and destroy the oscillating device or mirror.

U.S. patent application Ser. No. 10/384,861 describes several techniques for creating the pivotal resonance of the mirror device about the torsional hinges. Thus, by designing the mirror hinges to resonate at a selected frequency, a scanning engine can be produced that provides a scanning beam sweep with only a very small amount of energy required to maintain oscillation at resonance.

As will also be appreciated by one skilled in the art, the resonant frequency of a pivotally oscillating device or mirror about torsional hinges will vary as a function of the stress loading along the axis of the hinges. These stresses build up as a result of residual stress on the hinge from the assembly process as well as changes in the environmental conditions, such as for example, changes in the temperature of the packaged device. For example, the Young's modulus of silicon varies over temperature such that for a MEMS type pivotally oscillating device made of silicon, clamping the device in a package such that it is restrained in the hinge direction will cause stress in the hinges as the temperature changes. This in turn will lead to drift in the resonant frequency of the pivotal oscillations.

Since applications that use a pattern of light beam scans, such as laser printing and projection imaging require a stable and precise drive to provide the signal frequency and scan velocity, the changes in the resonant frequency and scan velocity of a pivotally oscillating mirror due to temperature variations can restrict or even preclude the use of the device in laser printers and scan displays. Further, as was mentioned above, if the stress loading is increased above the maximum acceptable levels for a given rotational angle, the reliability and operational life of the device can be unacceptably reduced or dramatically ended by shattered hinges.

### SUMMARY OF THE INVENTION

The issues and problems discussed above are addressed by the present invention by providing a pivotally oscillating mirror, or other oscillating resonant structure or device that includes circuitry for rapidly bringing the device to its operating deflection amplitude and at the resonant frequency. The oscillating device is a MEMS device comprising a functional surface, such as for example, a reflecting surface or mirror, supported by a pair of torsional hinges. The pair of torsional hinges enables the functional surface or mirror to pivotally oscillate, and each hinge extends from the functional surface to an anchor. The anchor may comprise a single support frame or a pair of support pads and is mounted to a support structure.

The oscillating device or mirror and methods also comprise circuitry for generating and applying energy drive pulses to the oscillating structure or mirror to initiate and maintain oscillations of the device or mirror. Typically, the energy drive pulses are electrical pulses driven through a drive coil to create a magnetic field. The magnetic field of the coil interacts with a permanent magnet mounted to the torsional hinged structure to cause the structure to oscillate. A sensor is also included for determining the deflection amplitude, and when the oscillating device is a torsional hinged mirror, a photosensor is used to determine the deflection amplitude or beam sweep.

According to the present invention, at start up, first energy drive pulses are generated and applied to the torsional hinged oscillating device to cause the structure to start oscillating. As a result of other features of the invention, these initial drive pulses can have a greater duty cycle than has been typically used in the prior art systems at start up. The frequency of the first drive pulses is then continuously increased and/or decreased through a range of frequencies that includes the resonant frequency of the device. As the frequency of the oscillating device approaches resonance, the deflection amplitude will significantly increase until the sensor indicates a first selected deflection amplitude has been reached. Typically, to avoid damage to the torsional hinges, the first selected deflection amplitude is less than the desired operational deflection amplitude. When the deflection amplitude reaches the first selected value, application of the energy drive pulse is interrupted for a few cycles to allow the oscillation to settle into the resonant frequency of the device. The resonant frequency is then determined by any suitable manner, and second energy drive pulses are generated and applied to the oscillating structure. The second energy drive pulses are substantially at the resonant frequency of the device and may have a smaller duty cycle than the first energy drive pulses. The duty cycle of the second energy drive pulses is then adjusted until the deflection amplitude reaches an operational deflection amplitude value.

In the event of transient events, controller failures, etc. that could damage the torsional hinges or failure of the controlling circuitry, the second energy drive pulses are turned off until the deflection amplitude decreases to a safe level.

The foregoing has outlined rather broadly the features and technical advantages of the present invention in order that the detailed description of the invention that follows may be better understood. Additional features and advantages of the invention will be described hereinafter, which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example of a single axis resonant functional surface, such as a mirror surface, having a support frame for generating a beam sweep;

FIG. 1A is a cross-sectional view taken along line 1A-1A of FIG. 1;

FIG. 2A is an illustration of another embodiment of a single axis elongated ellipse-shaped torsional hinged functional surface such as a mirror suitable for use with the present invention;

FIG. 2B is a top view of an alternate embodiment of a single axis torsional hinged functional surface or mirror supported by a pair of hinge anchors rather than a support frame;

FIG. 3 is a simplified diagram using a torsionally hinged mirror device as a scanning engine for laser printers according to the teachings of the present invention;

FIGS. 4A and 4B illustrate the use of detector pulses to determine the deflection amplitude of the oscillating device of the present invention;

FIG. 5 is a logic block diagram of a resonant scanning mirror controller according to the present invention;

FIG. 6 is a “state machine” diagram showing the start up sequences of an oscillating mirror according to the present invention; and

FIG. 7 is an electrical circuit diagram of an H-Bridge driver suitable for use with the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Like reference numbers in the figures are used herein to designate like elements throughout the various views of the present invention. The figures are not intended to be drawn to scale and in some instances, for illustrative purposes, the drawings may intentionally not be to scale. One of ordinary skill in the art will appreciate the many possible applications and variations of the present invention based on the following examples of possible embodiments of the present invention. The present invention relates to a torsional hinged structure or apparatus with a moveable functional surface, such as a mirror or reflecting surface, and is particularly suitable for use to provide the repetitive modulated scans of a laser printer.

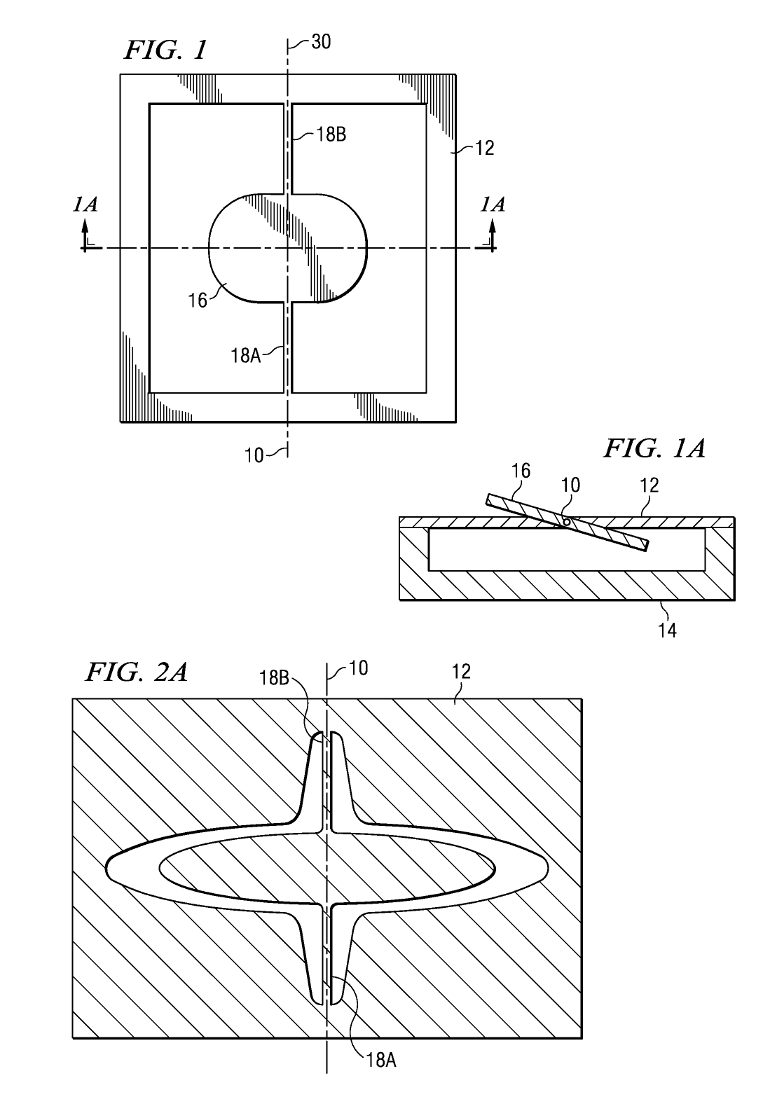

Referring now to FIG. 1, there is shown a top view of an apparatus having a single pair of torsional hinges for pivoting around a first axis 10. As shown, the apparatus of FIG. 1 includes a support member 12 suitable for mounting to a support structure 14 as shown in FIG. 1A. FIG. 1A is a simplified cross-sectional view taken along line 1A-1A of FIG. 1. Although the apparatus and methods of this invention are suitable for controlling the resonant pivoting frequency and deflection amplitude of any torsional hinged functional surface 16, this invention is ideally suited for use with a device wherein the functional surface 16 is a reflective surface or mirror portion attached to support member 12 by a pair of torsional hinges 18a and 18b. The torsional hinged mirror having a resonant frequency is suitable for use as the scanning engine of a laser printer or image display. Consequently, the following discussion will be with respect to a pivotally oscillating mirror, but it is not intended to be limited to such use unless so limited by the claims.

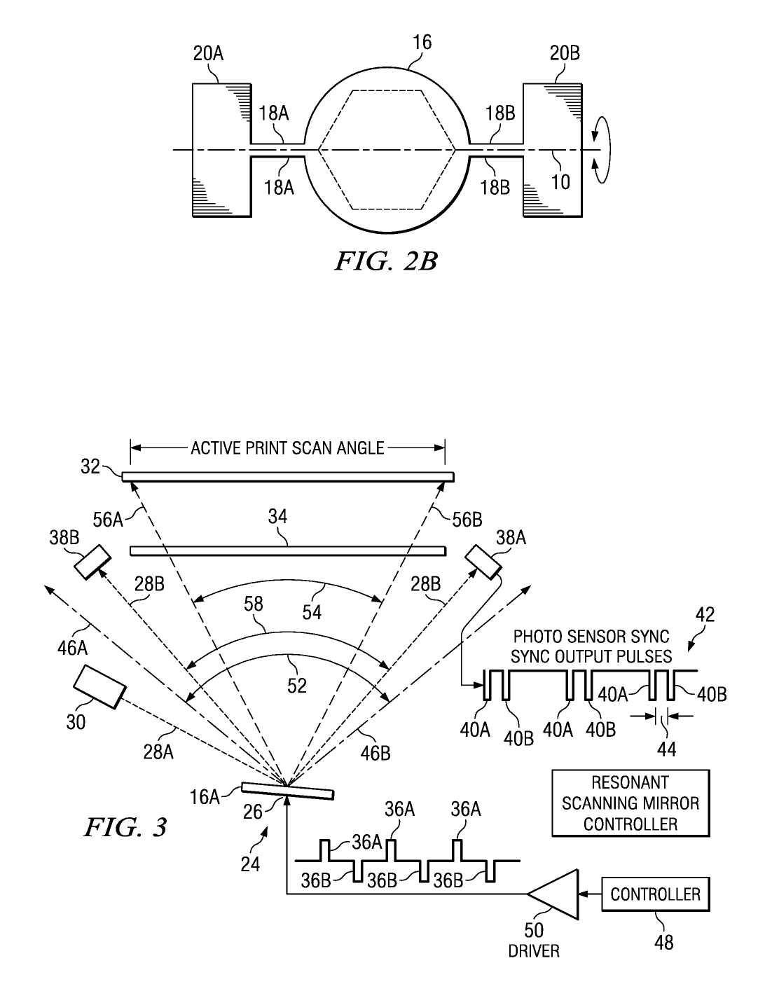

Although the apparatus of FIG. 1 includes a support member or frame 12, functional surface or mirror 16 may be manufactured by eliminating the support member 12 and extending the torsional hinges 18a and 18b from the functional surface or mirror 16 to a pair of hinge anchors 20a and 20b as shown in FIG. 2B. The hinge anchors 20a and 20b are then attached or bonded to the support structure 14 as shown in FIG. 1A. FIG. 2B also illustrates that the mirror or functional surface 16 may have any suitable shape or perimeter such as the hexagon shape indicated by dotted line 22. Other suitable shapes may include oval, square or octagonal. For example, FIG. 2A is particularly suitable for use with a mirror in providing a resonant beam sweep. As can be seen, the mirror portion 16 of FIG. 2A is a very elongated ellipse shape having a long dimension of about 5.5 millimeters and a short dimension of about 1.2 millimeters.

Referring now to FIG. 3, a single axis analog torsional hinged mirror is illustrated as the scanning engine for a resonant scanning mirror type laser printer. As shown, there is a mirror apparatus 24 such as discussed above with respect to FIG. 1 through FIG. 2B that includes a support member (not shown in FIG. 3) supporting a mirror or reflective surface 16 by the single pair of torsional hinges (not shown) that lie along pivoting axis 26. Thus, it will be appreciated that if the oscillating mirror can be maintained in a resonant state by a drive source, the mirror can be used to cause a resonant oscillating light beam across a photosensitive medium target 32. As will be appreciated by those skilled in the art, the oscillating light beam may be a series of modulated scanning beams for forming an image on the photosensitve medium.

Thus, the system of the embodiment of FIG. 3 uses the single axis mirror apparatus 24 to provide the right to left, left to right resonant sweep of the torsional hinged structure such that the reflective surface of the mirror 16a intercepts the light beam 28a emitted from light source 30 (illustrated as a laser light source) and provides the resonant sweep motion across a receiving medium 32 after passing though a lens 34. Of course, when used as the scanning engine of a laser printer, the target or medium 32 will typically be moving at a speed synchronized with the beam sweep.

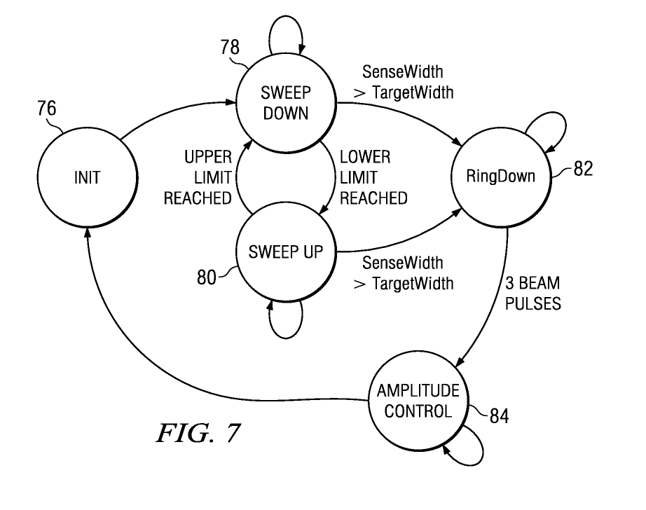

From the above discussions, it will be appreciated that careful regulation of the beam sweep or deflection amplitude is of utmost importance. Unfortunately, the environment may also introduce various difficulties in maintaining a stable scanning engine. More specifically, changes in temperature can also result in problems. For example, as has been discussed, the torsional hinged mirror assembly is typically made of silicon and is mounted or clamped in a fixed position during the packaging process. However, as will be appreciated by those skilled in the art, the Young's modulus of Si (silicon) varies with temperature changes. Consequently, constraining the silicon device from movement along the hinge axis may result in the resonant frequency of the device drifting with the changes in the temperature. Furthermore, the presence of such environmental stress along the axis of the hinges will change the magnitude of the forces necessary to restore the mirror to a relaxed or neutral position with respect to the pivot angle of the mirror; this in turn will change the “scan velocity” of the engine. In addition, there may be a difference in the CTE (coefficient of thermal expansion) of the silicon mirror device and the material used as the support structure and other elements of the packaging. These differences in the CTE of the silicon mirror device and other materials used in packaging the scanning engine may produce additional stress in the torsional hinge. The effects of these stresses resulting from temperature changes, as well as stresses resulting from other sources, lead to such large variations of the resonant frequency and of scan velocity that the use of a resonant mirror as the scanning engine may be precluded or significantly restricted. In the illustrated embodiment, the mirror oscillations are driven by a series of energy pulses, such as positive electrical pulses 36a and negative electrical pulses 36b, provided by a driving circuit. An H-Bridge driving circuit such as the one shown in FIG. 7 is an example of a suitable source of pulses 36a and 36b.

At start up, the energy drive pulses have substantially a constant duty cycle and amplitude. However, the frequency of the pulses is varied through a range of frequencies that includes the resonant frequency of the torsional hinged structure or mirror 16a. As the varying frequency of the drive pulses approaches the resonant frequency of the structure, the deflection amplitude or extent of the beam sweep is greatly increased.

Therefore, as shown in FIG. 3, there is included a sensor 38a or other means to determine when the scanning structure reaches a pre-selected target deflection amplitude. The target deflection amplitude generally cannot be achieved with the start up constant amplitude energy drive pulses except at a small frequency range on each side of and including the resonant frequency of the device. When the selected deflection amplitude is sensed, the application of the energy drive pulses is interrupted so that the oscillating structure or mirror 16a will settle into oscillations at the resonant frequency of the structure or mirror.

As an example, if the torsional hinged device is a resonant mirror that reflects a sweeping laser beam, the sensor 38a is located close to one end of the beam sweep and provides an electrical pulse 40a as the beam sweep (which is proportional to the angular deflection) of the torsional hinged device, passes the sensor 38a. After passing the sensor 38a, the sweep of the light beam is almost at the end of the sweep or deflection, and therefore, the beam sweep comes to a stop and reverses its direction such that a second pulse 40b is generated when the return sweep passes the sensor. These first 40a and second 40b pulses are illustrated as a stream of detector pulses 42. Also, since the laser beam is sweeping or oscillating at a constant frequency (the resonant frequency), the spacing 44 between the two pulses is proportional to the deflection amplitude.

The actual resonant frequency is then determined by the controller 48 and another series of energy drive pulses, having the resonant frequency or a frequency slightly offset from the resonant frequency that will maintain the actual resonant frequency, are again applied to the scanning mirror or structure 16a. The duty cycle of the energy drive pulses is then adjusted until the deflection amplitude of the resonant oscillating structure reaches the operational (or a second) deflection amplitude value as indicated by the lines 46a and 46b representing the extent of the operational deflection amplitude. A continuous string of energy pulses, having the duty cycle, as adjusted, and the resonant or selected frequency are provided to the torsional hinged structure 16a such that the oscillating mirror or structure continues to oscillate at the resonant frequency and the operational deflection amplitude.

It will be appreciated that the selected frequency of the energy drive pulse may be the same as the resonant frequency of the torsional hinged device. However, although some embodiments may use a frequency that is slightly offset from the resonant frequency to compensate for any phase shifts that occur in the system.

In still another embodiment, the method and apparatus of the invention may also be used to protect the device hinges from overstressing due to failure of the controller 48 that controls the generation of the energy drive pulse, or to protect against severe transient events. To provide such protection, the deflection amplitude is also monitored to determine if the amplitude exceeds a third selected value that is greater than the operating amplitude. If so, the application of drive pulses is immediately interrupted until the deflection amplitude decreases to a safe value. Once the deflection amplitude has decreased to a safe value, the drive pulses are again applied, but with a lower duty cycle.

The present invention solves these difficulties and problems by methods and apparatus that maintain the resonant frequency and/or scan velocity of the pivotally oscillating mirror.

Referring again to the simplified diagram of a laser printer incorporating the teachings of the present invention is shown in FIG. 3. It should be understood that FIG. 3 is not to scale and the deflection angles are intentionally shown greater than actually used so as to simplify the explanation. The advantages of the present invention may be used to bring any torsional hinged device rapidly up to resonant speed and to the operating deflection amplitude at start up. However, the invention is particularly useful for controlling a resonant scanning mirror and consequently the following discussion and description are again discussed with respect to such a resonant scanning mirror 16a. This limited discussion, however, is not intended to limit the scope of the invention or the application of the claims to a resonant scanning mirror.

As discussed above, a resonant scanning mirror 16a is aligned to receive a beam of light 28a from a light source such as laser light source 30. The resonant mirror 16a pivots at resonance about a pair of torsional hinges (not shown) that lie along the pivot axis 26. As the mirror 16a oscillates about pivot axis 26, the light beam 28a is reflected as light beam 28b that moves back and forth between two maximum deflection amplitude limits 46a and 46b. The maximum deflection amplitude is determined by the deflection energy provided by energy drive signals to the oscillating mirror 16a. According to the present invention, electrical pulses 36a and 36b having a predetermined or selected amplitude are provided to at least one drive coil (not shown) that creates a magnetic field that interacts with a permanent magnet (not shown) on the mirror to cause oscillation around the pivot axis 26. Also as shown in the diagram of FIG. 3, both positive electrical pulses 36a and negative electrical pulses 36b are provided from a drive circuit such as H-Bridge driver circuit 50 at or proximate to the resonant frequency of the mirror. It will be appreciated that although both positive and negative electrical pulses may be preferable and provide a more stable system, positive pulses alone, or negative pulses alone may be used and are intended to be covered by the scope of the invention. In addition, although a negative pulse and a positive pulse are illustrated as being generated for each oscillating cycle of the mirror, the pulses cold be limited to every other cycle, every third cycle, etc. for example.

Referring again to FIG. 3, and assuming the angle 52 between the two lines 46a and 46b represents the desired operational deflection amplitude at the mirrors resonant frequency, and that the angle 54 between lines 56a and 56b represents the portion of the beam sweep that is modulated with information that is to be printed. This angle 54 is referred to herein as the active print scan angle. As shown, the modulated light beam between lines 56a and 56b is collected by a lens 34 and then focused on a light sensitive medium 32 (such as for example only, a rotating drum) to be used for printing. Also included is a photosensor 38a that provides an electrical pulse 40a when the oscillating light beam passes over the sensor 38a. As shown, the photosensor is at a beam angle 58 or position that is well beyond the active print scan angle 54 between lines 56a and 56b, but still less than the position of the beam when the beam is at the desired operational angle 52 or deflection position as indicated by lines 46a and 46b. It will also be appreciated that since line 46b represents the maximum deflection of the beam sweep to the right during actual operation of the laser printer, the travel speed of the beam has slowed to a complete stop and must then reverse its travel direction and move toward the maximum deflection position at line 46a. Therefore, the light beam passes sensor 38a as it moves to a position represented by line 46b where it stops and then reverses direction and again passes sensor 38a as it moves through a complete sweep to line 46a. The sensor 38a generates the two pulses 40a and 40b, one pulse for each time the beam passes photo sensor 38a. It should also be appreciated that since the resonant frequency of the mirror remains substantially constant, the deflection amplitude of the beam sweep is proportional to the time (represented by the spacing 44) between the two pulses.

It should also be appreciated that although a single photosensor 38a is illustrated in the embodiment of FIG. 3, a second photosensor 38b, shown in dashed lines, may be used at the opposite end of the beam sweep or deflection amplitude.

As discussed above, if an energy pulse waveform drives the oscillating device or mirror at its resonant frequency, the amplitude of the sweep or deflection can increase to a wide angle as indicated by lines 46a and 46b of FIG. 3. For most situations, this is very advantageous since a very low power signal can move the mirror or device over the required operating range. Unfortunately, if the deflection amplitude increases to too great a value, the hinges may be overstressed and fail.

Therefore, the photosensor 38a is located outside of the active print area or angle 54 to detect the reflected laser beam and will generate output pulses each time the reflected laser beam crosses or passes over the sensor 38a. As mentioned, the timing between two consecutive pulses and represented by double headed arrow 44 can be used to calculate the deflection amplitude.

Unfortunately, the deflection amplitude must typically be within about 20% of the operating deflection value if it is to be picked up by sensor 38a. This is because, when the mirror is driven by energy signals that are significantly different than the resonant value, the overall oscillating motion may be less than 1% of the operational value. However, when driven at resonance, the mirror may be driven to a value that is 500% larger than the operational value. Of course, such a large value is well beyond the movement that will damage or destroy the hinges.

Therefore, it is necessary to drive the oscillating device with a resonant signal that has sufficient amplitude to reach and pass over the sensor 38a, and at the same time be small enough to avoid any damage to the hinges.

As will also be appreciated by those skilled in the art, and as was briefly discussed above, mechanical stress on the hinges will cause a change in the basic resonant frequency of a torsional hinged device. Therefore it will be appreciated that a change in temperature may result in the hinges being stressed so as to cause a resonant frequency change. As will be understood from the above discussion, a change in the resonant frequency of an oscillating mirror or other device would change the deflection amplitude if the drive pulses were continued at the original resonant frequency. Therefore, as will be discussed, the method of the present invention can also be used to adjust the frequency or duty cycle of the energy drive pulses or signals so as to control the motion of the mirror or device, and so that the deflection amplitude remains at the operational value.

In the example of FIG. 3, the desired mirror deflection amplitude is about 23 degrees from the center position, the detector 38a is located at about 18 degrees, and the drive frequency is about 3200 Hz. The default drive current (or voltage) is selected to guarantee that the mirror moves the beam over the detector twice per cycle.

Knowledge of the drive frequency (i.e., the resonant frequency) and measurement of the time between detector pulses at 18 degrees enables a direct calculation of the mirror angle for control purposes.

More specifically, the mirror deflection when operating near resonance is give by the equation:
θ=A sin (φ), where
θ=deflection angle,
A=deflection amplitude,
φ=ωt=period argument (ω=frequency, and t=time).

Therefore, it is possible to solve for the two times per cycle when θ≈D (the detector position). The first detector crossing occurs at
φ1=arcsin(D/A).

The second detector crossing occurs at
φ2=180°−arcsin(D/A).

The spacing width, w, between the two pulses is given by

$$w = ϕ 2 - ϕ1 = 180 ° - arcsin ( D / A ) = 180 ° - 2 arcsin ( D / A ) .$$

Expressed as a function of the half-period, H, the width is
w/H=(180°−2 arcsin(D/A))/180°.

In this example, with desired deflection amplitude of 23 degrees and sensor mounted at 18 degrees, the pulse spacing width will be

$$w / H = ( 180 ° - 2 arcsin ( 18 / 23 ) ) / 180 ° = 0.427777 .$$

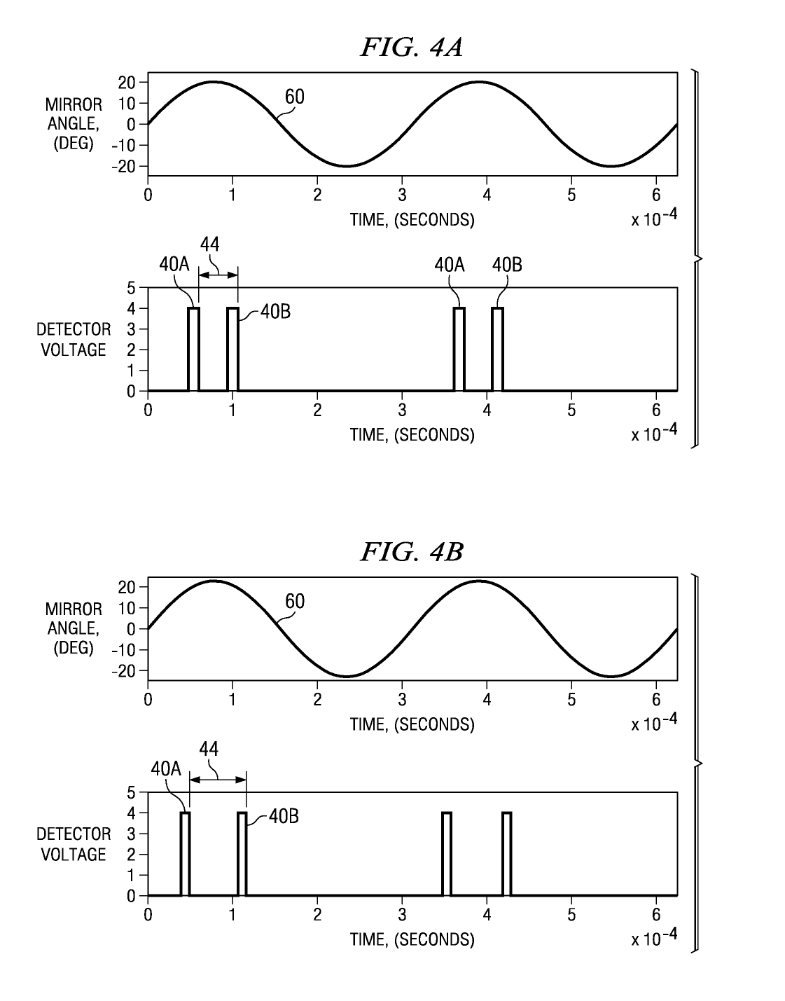

FIG. 4A is a graph showing the mirror angle 60 and the two detector pulses 40a and 40b for a mirror angle of only 20 degrees rather than 23 degrees. Thus, logic in the system controller 48, to be discussed later, measures the time 44 between the two detector pulses. In this example, with a deflection angle of only 20 degrees, the time 44 between the two pulses is less than the time between the pulses when operated at the operational value.

FIG. 4B on the other hand, shows a similar graph after the controller 48 has adjusted the energy drive pulses to increase the deflection amplitude to the operational level of 23 degrees. As shown, the two detector pulses 40a and 40b are further apart than in FIG. 4A.

As mentioned, the deflection amplitude may be determined by measuring the spacing between the adjacent pair of sensor pulses. The width of the pulse-pair spacing is given by the formula:
W_{M}=H*[(180°−2 arcsin(D/A))/180°]
where

W_{M}=measured pulse-pair spacing width

H=half-period of the driving waveform

D=angular position of the beam detector.

A=deflection amplitude

Similarly, the target width, W_{T}, is calculated by inserting the desired target deflection angle, AT, into the above formula, resulting in:
W_{T}=H*[(180°−arcsin(D/A_{T}))/180°].

The term inside the brackets includes an arcsin function, a multiplication, and a division operation, and would be difficult to compute at run-time. However, the term inside the brackets can be calculated during the product design time and inserted as a constant.

Therefore, it will be appreciated that one purpose of the controller is to make the deflection amplitude match the target deflection amplitude. When the amplitude matches the target amplitude, the pulse-pair width measured by the sensor will match the target width. At that point, the ratio W_{T}/W_{M} will be 1.00.

As will be appreciated, the drive time is the duration of each half-period during which the driver 50 is active and applying voltage to the mirror drive coil.

Simplified equations for explanation purposes are:
drive time=nom drive time*target width/sense width [Eq. 1]
and
nom drive time(t+T)=(nom drive time(t)*(1−G))+(drive time(t)*G) [Eq. 2]

As stated above, the previous equations are the simple basic equations. The actual equations that may be used are slightly different and include additional terms to minimize quantization and saturation errors in the calculations.

In any event, the variable nom drive time is the nominal on-time of the driving waveform, which varies slowly to handle any drift in the electromechanical properties of the mirror or the driver.

The actual drive time varies and is the value that is sent to the driver waveform generator, and that responds more quickly to disturbances. When the deflection amplitude decreases below a target value, the width 44 of the sensor pulse-pair becomes smaller, and the drive time calculated by Eq. 1 above will become larger. When the sensed width matches the target width, drive time will match the nom drive time.

Eq. 2 slowly adjusts the nominal drive time to match the actual drive time required to hold the deflection amplitude at the desired target level. The gain term, G, in Eq. 2 controls the rate at which the two values converge, and will lie in the range from 0 to 1. With small values of G (less than 1/32), the two drive time values will converge slowly, resulting in sluggish start-ups. For large values of G (>¼), the response will overcorrect, resulting in slowly damped oscillation in the deflection amplitude.

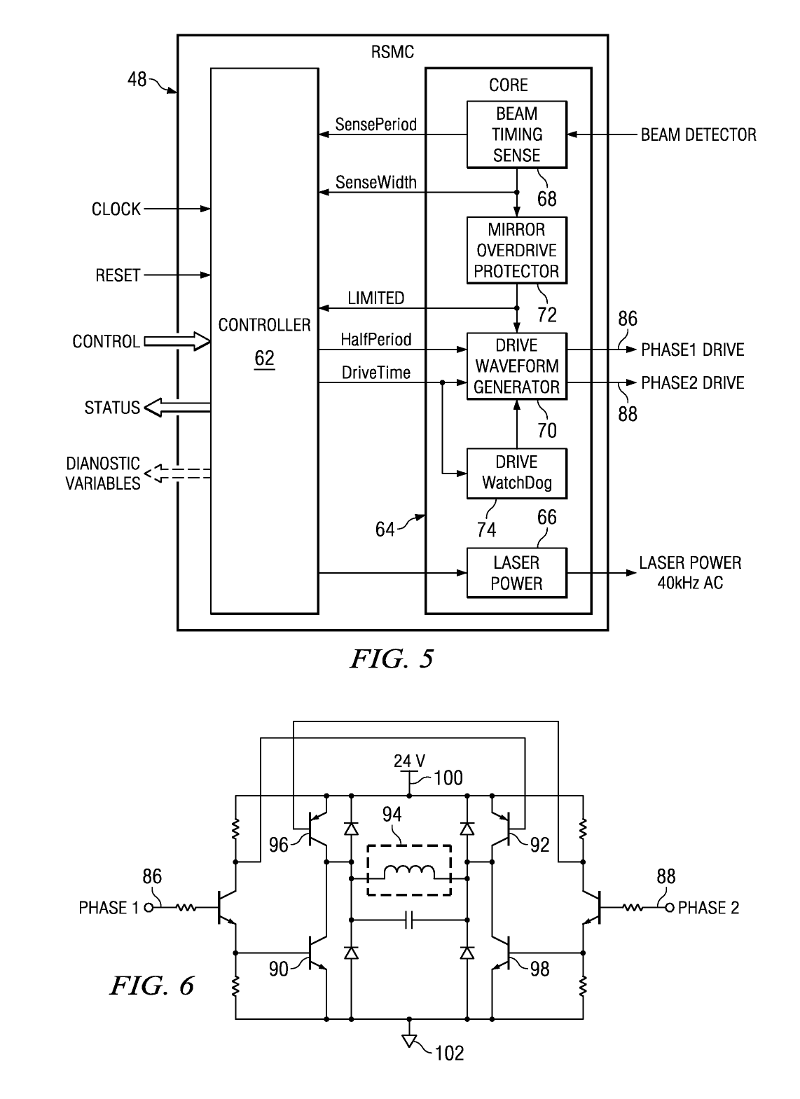

Referring now to FIG. 5, there is illustrated a simplified block diagram of the control circuitry, hereinafter referred to as the resonant scanning mirror controller or RSMC 48. As shown, the RSMC 48 includes a processor or main controller 62 for carrying out necessary calculations, data storage, etc. The processor or main controller may be selected from various commercially available processors or logic devices. As will be discussed in greater detail hereinafter, the main controller or processor 62 also provides the controls and start up command signals that achieve the advantages of the present invention. There is also included, a core portion 64 of RSMC 48, which is specific to the present system. The core portion 64, for example, includes a laser power control 66 that controls the power of the laser beam 28a and a beam timing circuit 68 that receives the two pulses 40a and 40b from the beam detector 38a and determines the spacing or timing 44 between pulses. In addition, there is the drive waveform generator 70, which receives commands from the main controller or processor 62 and provides the drive pulses with the appropriate frequency, phasing, duty cycle, and amplitude to control the driver. According to one embodiment, the output of the drive waveform generator provides signals to an H-Bridge driver 50, which will also be discussed hereinafter.

An overdrive protection circuit 72, which protects the oscillating mirror or device during start up or in the event of transient conditions that could damage the device is also included.

For example, during start up or other transient events, the RSMC controller 48 could command values of drive time that could damage the mirror if sustained for long periods. Therefore, the mirror overdrive protector 72 function in the RSMC core monitors the sensor pulse-pair width or timing 44 for large mirror deflections. When the deflection amplitude exceeds a predetermined safety limit, the protector disables the output such as from an H-Bridge driver 50 for one period and notifies the RSMC main controller 61. When the deflection amplitude drops below the limit, the H-Bridge driver 50 is automatically re-enabled.

Likewise, a drive watchdog circuit 74 is included that will protect the device in the event of a fault or failure of the main controller 62. The drive watchdog circuit 74 helps protect the mirror in the event of a fault or failure in the mirror controller 62. In normal operation, the RSMC controller updates a drive time register in the RSMC core once per period. In the event that three periods elapse without an update to the drive time register, the drive watchdog circuit 74 will disable the signal to the H-Bridge drive 50 to protect the mirror. Writing to the drive time register will re-enable the H-Bridge drive 50.

Referring now to FIG. 6, there is shown a “state machine” that illustrates the sequence of events required in a start up mode, according to the present invention. As shown, the first action as indicated by the state machine condition 76 is initializing the circuitry in the RSMC 48 including setting the drive pulse to a beginning frequency, amplitude, and duty cycle. As was mentioned above, the duty cycle may purposely be initially set to a value greater than the final or operational value to help decrease the overall start up time. In addition, high and low frequency limits between which the system will be permitted to operate may also be set along with a nominal pulse, amplitude, or voltage. First drive pulses are then provided to start the device or mirror oscillating. The frequency of the pulse is then decreased as indicated by the sweep down condition 78 of the state machine until a lower limit is reached or until the beam passes over the photo detector and generates detector pulses having a first predetermined timing or spacing 44 as discussed above. In the event the lower frequency limit is reached first, the frequency of the pulses stops decreasing and begin increasing as indicated by the sweep up condition 80 of the state machine. If the beam amplitude did not increase the beam deflection sufficiently to move the beam over the photo detector two times on the sweep down phase, it may or may not do so on the sweep up phase. If it does not, the sweep up 80 and sweep down 78 conditions are repeated with slower sweep rates until the photo detector 38a generates a pair of pulses. This may take several cycles, but the deflection amplitude will continue to increase, and since the deflection is significantly greater at or proximate to the resonant frequency of the device, the frequency of the pulses at which the deflection amplitude is sufficient to pass the beam over the detectors two times, will likely be very close to the resonant frequency of the device.

In any event, once the deflection amplitude is sufficient to create a pair of pulses with a predetermined timing or spacing 44, the drive pulses are interrupted by disabling the H-Bridge driver 50. The oscillating device 16a is then allowed to ring down or settle into its resonant frequency as indicated by condition 82 of the state machine. This settle delay time must be long enough to allow the mirror oscillation to reach its natural resonant frequency, but not so long that the amplitude decays too low to be detected by the sensor 38a. In the preferred embodiment, the settle delay time was 3 cycles.

Once the actual resonant frequency is determined, the drive pulses having a frequency substantially equal to the determined resonant frequency are again applied to the oscillating device at a pre-selected duty cycle. It should also be noted that the actual frequency of the drive pulses may be slightly offset to a selected frequency to compensate for a system phase shift. The duty cycle of the energy drive pulses is then gradually adjusted until the deflection amplitude reaches the operational value as indicated by condition 84 of the state machine. Drive pulses with the resonant frequency (or the slightly offset selected frequency) and the adjusted duty cycle are then continuously provided to allow proper operation of the printer. The duty cycle is then continuously adjusted to maintain the desired deflection angle amplitude.

FIG. 7 illustrates the H-Bridge driver 50. According to one embodiment, the H-Bridge drive 50 is external to the RSMC 48. As shown, the H-Bridge 50 receives inputs from the phase one line 86 and the phase two line 88. Receiving a signal on phase one line 86 turns on the lower left transistor 90 and the upper right transistor 92 so as to send current through the mirror coil 94 from right to left. Similarly, receiving a signal on phase two line 88, turns on the upper left transistor 96 and the lower right transistor 98 and sends current through coil 94 from right to left. It is important that phase one and phase two not be on at the same time since this would provide a low resistance path from the power source line 100 directly to ground 102, which could, of course, damage the power supply. Thus, the logic in the RSMC 48 prevents this by ensuring that there is always a delay between the time one phase is off until the other phase is turned on.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for oscillating a torsional hinged scanning structure and rapidly driving the scanning structure to a selected deflection amplitude while oscillating at the resonant frequency comprising the steps of:
generating and applying first energy drive pulses to the structure to cause said scanning structure to oscillate;
varying the frequency of the drive pulses through a range of frequencies that includes the resonant frequency of the torsional hinged scanning structure;
determining when the scanning structure reaches a selected deflection angle or amplitude value;
interrupting the applying of said energy drive pulses to said scanning structure;
determining the resonant frequency of said scanning structure;
generating and applying second energy drive pulses to said scanning structure at said resonant frequency or at a selected frequency that maintains the oscillations of said scanning structure at its resonant frequency; and
adjusting the duty cycle of said second energy drive pulses until said scanning device reaches a second deflection angle or amplitude value.

2. The method of claim 1 wherein said oscillating torsional hinged scanning structure is a scanning mirror.

3. The method of claim 1 further comprising continuously generating and applying said second energy drive pulses having said selected frequency and an adjusted duty cycle that maintains said second deflection angle or amplitude value.

4. The method of claim 3 further comprising continuously adjusting the duty cycle of said second energy drive pulses to maintain the second deflection angle or amplitude value.

5. The method of claim 3 wherein said selected frequency is the same as said resonant frequency of said scanning structure.

6. The method of claim 3 wherein said selected frequency is offset from the resonant frequency of said oscillating structure to compensate for a phase shift of the structure.

7. The method of claim 3 further comprising:
determining if said deflection amplitude exceeds a third selected value;
if said deflection amplitude does exceed said third selected value, interrupting the application of energy drive pulse to said scanning structure and allowing the deflection amplitude to decay to a lower deflection amplitude; and then
generating and applying new second energy drive pulses having said selected frequency and a duty cycle less than said adjusted duty cycle.

8. The method of claim 1 wherein said first deflection amplitude value is less than said second deflection amplitude value.

9. The method of claim 1 further comprising:
determining if said deflection amplitude exceeds a third selected value;
if said deflection amplitude exceeds said third selected value, interrupting the application of energy drive pulse to said scanning structure and allowing the deflection amplitude to decay to a lower deflection amplitude; and then
generating and applying new second energy drive pulses having said selected frequency and a duty cycle less than said adjusted duty cycle.

10. The method of claim 1 further comprising providing a sensor proximate the end of said oscillating structure deflection such that the sensor provides a pair of electrical pulses, a first pulse of said pair of pulses representing the position of the oscillating structure as it travels in a first direction and the second pulse of said pair of pulses representing the same position of the structure after it stops and reverses its direction of travel.

11. The method of claim 10 wherein said deflection amplitude of said scanning structure is determined by monitoring the spacing between said pair of pulses.

12. The method of claim 11 and further comprising a status indication when said spacing between said pair of pulses is within a selected range for a selected amount of time.

13. The method of claim 1 wherein adjusting the duty cycle comprises continuously adjusting the duty cycle of the second energy drive pulses to maintain the second deflection angle or amplitude value.

14. Apparatus for oscillating a torsional hinged scanning structure and rapidly driving the scanning structure to a selected deflection amplitude and angle of deflection while oscillating at the resonant frequency comprising:
a torsional hinged scanning structure having said resonant frequency and oscillating between positive and negative angles of deflection;
an energy source for generating and applying energy drive pulses to cause said scanning structure to oscillate, said energy source varying the frequency and duty cycle of said drive pulses in response to control signals;
a sensor located at a position proximate to, but less than, one of said positive and negative angles of deflection so that said sensor provides a first pulse on a forward oscillation of said structure and a second pulse on a reverse oscillation of said structure; and
a controller connected to receive said first and second pulses from said sensor, said controller including circuitry for determining a deflection angle or amplitude value of said scanning structure in response to said first and second pulses, and circuitry for providing said control signals, said control signals comprising;
a first set of control signals applied to said energy source such that the frequency of said generated energy drive pulses varies through a range of frequencies that includes the resonant frequency of the torsional hinged scanning structure, said first set of control signals being applied until first and second sensor pulses are received by said controller indicating a selected deflection angle has been reached and so that the resonant frequency of said torsional hinged structure can be determined,
a second set of control signals to maintain said oscillations at said resonant frequency and to vary the duty cycle of said drive pulses to maintain a selected angle of deflection or amplitude.

15. The apparatus of claim 14 wherein said oscillating torsional hinged scanning structure is a scanning mirror.

16. The apparatus of claim 14 wherein said controller continuously generates said second set of control signals.

17. The apparatus of claim 14 wherein said frequency of said drive pulses is offset from the resonant frequency of said oscillating structure to compensate for a phase shift of the structure.

18. The apparatus of claim 15 further comprising a beam of light directed toward said oscillating mirror and wherein said sensor is a photosensor.

19. Apparatus for oscillating a torsional hinged scanning structure and rapidly driving the scanning structure to a selected deflection amplitude and angle of deflection while oscillating at the resonant frequency comprising:
a torsional hinged scanning structure having said resonant frequency and oscillating between positive and negative angles of deflection;
an energy source for generating and applying energy drive pulses to cause said scanning structure to oscillate, said energy source varying the frequency and duty cycle of said drive pulses in response to control signals;
a sensor located at a position proximate to, but less than, one of said positive and negative angles of deflection so that said sensor provides a first pulse on a forward oscillation of said structure and a second pulse on a reverse oscillation of said structure;
a controller connected to receive said first and second pulses from said sensor, said controller comprising;
means for varying the frequency of the drive pulses through a range of frequencies that includes the resonant frequency of the torsional hinged scanning structure;
means for determining when the scanning structure reaches a selected deflection angle or amplitude value;
means for interrupting the applying of said energy drive pulses to said scanning structure;
means for determining the resonant frequency of said scanning structure;
means for generating and applying second energy drive pulses to said scanning structure at said resonant frequency or at a selected frequency that maintains the oscillations of said scanning structure at its resonant frequency; and
means for adjusting the duty cycle of said second energy drive pulses until said scanning device reaches a second deflection angle or amplitude value.

20. The apparatus of claim 19 wherein said oscillating torsional hinged structure is a scanning mirror.

21. The apparatus of claim 19 wherein said controller continuously generates said second energy drive pulses.

22. The apparatus of claim 19 wherein said frequency of said drive pulses is offset from the resonant frequency of said oscillating structure to compensate for a phase shift of the structure.
